(19) United States
(12) Patent Application Publication
(10) Pub. No.: US 2004/0018432 A1
(43) Pub. Date: Jan. 29, 2004

(54) Battery

(76) Inventors: Momoe Adachi, Tokyo (JP); Eishi Endo, Kanagawa (JP); Atsumichi Kawashima, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/405,512

(22) Filed: Apr. 2, 2003

(30) Foreign Application Priority Data
Apr. 2, 2002 (JP) P2002-099944

(51) Int. Cl. H01M 10/40

(52) U.S. Cl. 429/343; 429/326

(57) ABSTRACT

The invention provides a battery with improved battery characteristics such as battery capacity and a cycle characteristic. The battery has a rolled electrode body obtained by rolling strip-shaped cathode and anodes sandwiching a separator in between. A lithium metal is deposited on the anode during charging, and the capacity of the anode is expressed by the sum of a capacity component determined by insertion/extraction of lithium and a capacity component determined by deposition/dissolution of a lithium metal. The separator is impregnated with an electrolyte obtained by dissolving a lithium salt in a solvent. To the electrolyte, carboxylate ester is added. Consequently, a film is formed on the surface of the anode, thereby suppressing a decomposition reaction of the solvent and a reaction between the deposited lithium metal and the solvent. By CO₂ generated by decomposition of the carboxylate ester, the deposition/dissolution efficiency of the lithium in the anode is improved.

### BACKGROUND OF THE INVENTION

1. Field of the Invention

The present invention relates to a battery having a cathode, an anode, and an electrolyte and, more particularly, to a battery in which capacity of an anode is expressed by the sum of a capacity component determined by insertion and extraction of a light metal and a capacity component determined by deposition and dissolution of the light metal.

2. Description of the Related Art

In recent years, the size and weight of a portable electronic device typified by a portable telephone, a PDA (Personal Digital Assistant) terminal device, or a notebook-sized computer is being vigorously reduced. Consequently, as part of it, improvement in energy density of a battery, particularly, a secondary battery as a driving source of the devices is strongly demanded.

An example of a secondary battery realizing high energy density is a lithium ion secondary battery having an anode made of a material such as a carbon material capable of inserting and extracting lithium (Li). Since a lithium ion secondary battery is designed so that lithium inserted in the anode material is always in an ion state, the energy density largely depends on the number of lithium ions which can be inserted in the anode material. It can be therefore considered that by increasing the inserting amount of lithium ions, the energy density of a lithium ion secondary battery can be further improved. However, the inserting amount of graphite which is believed to be a material capable of inserting and extracting lithium ions most efficiently at present is theoretically limited to 372 mAh in electric amount conversion per gram. Recently, by vigorous development activities, the inserting amount is being increased to the limit value.

Another secondary battery realizing high energy density is a lithium secondary battery having an anode made of a lithium metal and using only deposition and dissolution reaction of the lithium metal as a reaction of the anode. A lithium secondary battery is expected to achieve energy density higher than that of a lithium ion secondary battery since a theoretical electrochemical equivalent of a lithium metal is as large as 2,054 mAh/cm³ which is 2.5 times as large as that of graphite used for the lithium ion secondary battery. Hitherto, many researchers and the like have been studied and developed to realize commercialization of lithium secondary batteries (for example, “Lithium Batteries”, edited by Jean-Paul Gabano, Academic Press, 1983, London, N.Y.).

However, the lithium secondary battery has a problem such that the discharge capacity deteriorates largely when charge and discharge is repeated and it is consequently difficult to realize commercialization. The deterioration in capacity occurs due to the fact that the lithium secondary battery uses the deposition/dissolution reaction of a lithium metal in the anode. Since the volume of the anode largely increases/decreases only by the capacity in correspondence with lithium ions moving between the positive and anodes in association with charge and discharge, the volume of the anode largely fluctuates and it suppresses reversible dissolution reaction and recrystallization reaction of a lithium metal crystal. Moreover, the higher the energy density is desired to be realized, the more the volume of the anode changes and deterioration in capacity becomes conspicuous.

The inventors herein therefore have newly developed a secondary battery in which the capacity of the anode is expressed by the sum of a capacity component determined by insertion and extraction of lithium and a capacity component determined by deposition and dissolution of lithium (refer to International Publication WO 01/22519 A1). Specifically, the anode is made of a carbon material capable of inserting and extracting lithium and the lithium is allowed to be deposited on the surface of the carbon material during charging. This secondary battery can be expected to have an improved charge/discharge cycle characteristic while achieving high energy density.

To commercialize the secondary battery, however, the characteristics have to be further improved and stabilized and it is indispensable to study and develop not only the material of the electrode but also electrolytes. Particularly, a side reaction occurs between an electrolyte and an electrode. When a side-reaction product is deposited on the surface of the electrode, internal resistance of the battery increases and the charge/discharge cycle characteristic conspicuously deteriorates. When a lithium metal is not smoothly deposited on the anode, the dissolution and recrystallization reaction does not easily reversibly develop and this also causes deterioration in the charge/discharge cycle characteristic.

The invention has been achieved in consideration of the problems and its object is to provide a battery with improved battery characteristics such as battery capacity and cycle characteristic.

A battery according to the invention comprises a cathode, an anode, and an electrolyte, wherein capacity of the anode is expressed by the sum of a capacity component determined by insertion and extraction of a light metal and a capacity component determined by deposition and dissolution of a light metal, and the electrolyte contains at least one of carboxylate ester and carboxylate ions.

In the battery according to the invention, the electrolyte contains at least one of carboxylate ester and carboxylate ions. Consequently, a decomposition reaction of the solvent is suppressed at the time of charging, and a reaction between a light metal deposited in the deposition/dissolution reaction of the light metal and a solvent is prevented. The deposition/dissolution efficiency of the light metal in the anode is also improved. Thus, battery characteristics such as the battery capacity and the cycle characteristic are improved.

Other and further objects, features and advantages of the invention will appear more fully from the following description.

### BRIEF DESCRIPTION OF THE DRAWINGS

FIG. 1 is a cross section showing the configuration of a secondary battery according to an embodiment of the invention.

FIG. 2 is a cross section enlargedly showing a part of a rolled electrode body in the secondary battery illustrated in FIG. 1.

### DETAILED DESCRIPTION OF THE PREFERRED EMBODIMENTS

An embodiment of the invention will be described in detail hereinbelow with reference to the drawings.

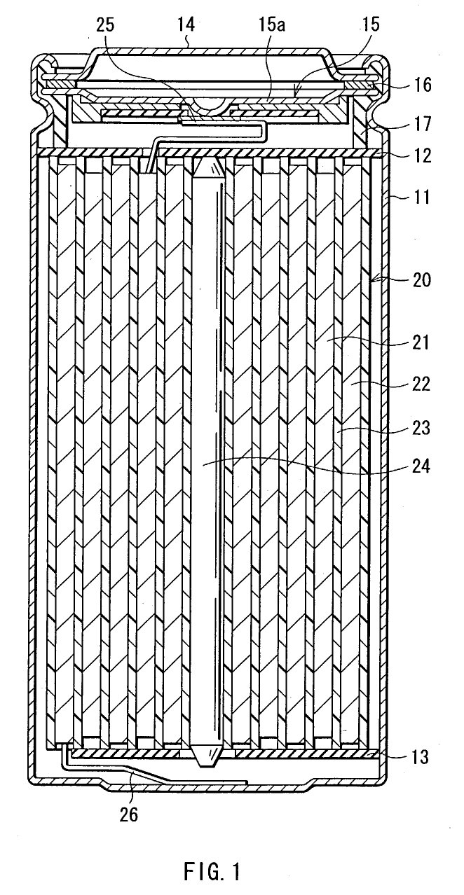

FIG. 1 shows a sectional structure of a secondary battery according to the embodiment of the invention. The secondary battery is what is called of a cylindrical type. In a battery can 11 having a substantially hollow cylindrical column shape, a rolled electrode body 20 obtained by rolling strip-shaped cathode 21 and anode 22 sandwiching a separator 23 in between is provided. The battery can 11 is made of, for example, iron (Fe) plated with nickel (Ni). One end of the battery can 11 is closed and the other end is open. In the battery can 11, a pair of insulating plates 12 and 13 are disposed perpendicular to the peripheral face of the roll so as to sandwich the rolled electrode body 20.

A battery cover 14, and a safety valve mechanism 15 and a positive temperature coefficient (PTC) device 16 which are provided on the inside of the battery cover 14 are attached to the open end of the battery can 11 by being caulked via a gasket 17 and the battery can 11 is sealed. The battery cover 14 is made of, for example, a material similar to that of the battery can 11. The safety valve mechanism 15 is electrically connected to the battery cover 14 via the PTC device 16. When the internal pressure of the battery increases to a predetermined value or higher due to internal short-circuiting, heating from the outside or the like, a disk plate 15a is turned upside down, thereby disconnecting the electrical connection between the battery cover 14 and the rolled electrode body 20. The PTC device 16 is used to limit current by increase in a resistance value when the temperature rises to thereby prevent abnormal heating caused by heavy current. The PTC device 16 is made of, for example, barium-titanate-based semiconductor ceramics. The gasket 17 is made of, for instance, an insulating material. Asphalt is applied on the surface of the gasket 17.

The rolled electrode body 20 is rolled around, for example, a center pin 24 as a center. A cathode lead 25 made of aluminum (Al) or the like is connected to the cathode 21 of the rolled electrode body 20, and an anode lead 26 made of nickel or the like is connected to the anode 22. The cathode lead 25 is welded to the safety valve mechanism 15, thereby being electrically connected to the battery cover 14. The anode lead 26 is welded and electrically connected to the battery can 11.

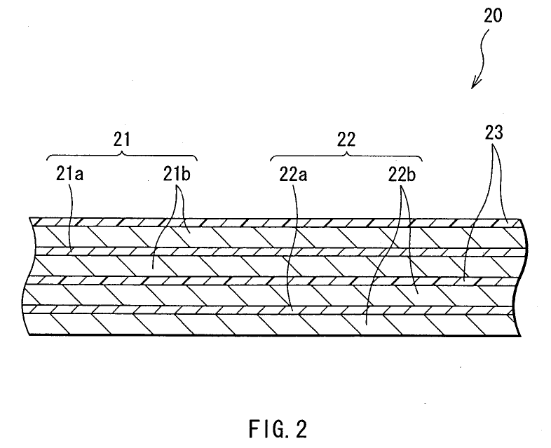

FIG. 2 enlargedly shows a part of the rolled electrode body 20 illustrated in FIG. 1. The cathode 21 has, for example, a structure in which a cathode mixture layer 21b is provided on both faces of a cathode collector 21a having a pair of opposite faces. Although not shown, the cathode mixture layer 21b may be provided only one of the faces of the cathode collector 21a. The cathode collector 21a has a thickness of, for example, about 5 μm to 50 μm and takes the form of metal foil such as aluminum foil, nickel foil, or stainless steel foil. The cathode mixture layer 21b has a thickness of, for example, 80 μm to 250 μm and contains a cathode material capable of inserting and extracting lithium as a light metal. When the cathode mixture layer 21b is provided on both faces of the cathode collector 21a, the thickness of the cathode mixture layer 21b is total thickness.

Examples of proper cathode materials capable of inserting and extracting lithium are lithium-contained compounds such as a lithium oxide, a lithium sulfide, and an interlayer compound containing lithium. A mixture of two or more kinds of lithium-contained compounds may be also used. Particularly, to increase energy density, a lithium composite oxide expressed by a general formula of Li_{z}MO₂ or an interlayer compound containing lithium are preferable. Preferably, M denotes one or more kinds of transition metals which are concretely cobalt (Co), nickel, manganese (Mn), iron, aluminum, vanadium (V), and titanium (Ti). “z” varies according to a charge/discharge state of a battery and is usually a value in the range of 0.05≦z≦1.10. It is also preferable to use LiMn₂O₄ having a spinel crystal structure or LiFePO₄ having an olivin crystal structure each having high energy density.

Such a cathode material is prepared by mixing, for example, a carbonate, nitrate, oxide, or hydroxide of lithium with a carbonate, nitrate, oxide, or hydroxide of a transition metal so as to become a desired composition, grinding the mixture, and after that, firing the resultant in an oxygen atmosphere at a temperature in a range from 600° C. to 1000° C.

The cathode mixture layer 21b contains, for example, a conductive agent and, as necessary, may also contain a binder. Examples of the conductive agent are carbon materials such as graphite, carbon black, and Ketjen black. One of the materials or a mixture of two or more of the materials is used. Except for the carbon materials, a metal material, a conductive high molecular weight material, or the like can be also used as long as the material has conductivity. Examples of the binder are synthetic rubbers such as styrene-butadiene rubbers, fluororubbers, and ethylene propylene dien rubbers, and high molecular weight materials such as polyvinylidene fluoride. One of the materials or a mixture of two or more of them is used. For example, when the cathode 21 and the anode 22 are wound as shown in FIG. 1, it is preferable to use very flexible styrene-butadiene rubber or fluororubber as a binder.

The anode 22 has, for example, a structure in which an anode mixture layer 22b is provided on both faces of an anode collector 22a having a pair of opposite faces. Although not shown, the anode mixture layer 22b may be provided only one side of the anode collector 22a. The anode collector 22a is made of, for instance, metal foil such as copper foil, nickel foil, or stainless steel foil having excellent electrochemical stability, electric conductivity and mechanical strength. Particularly, the copper foil is the most preferable since it has high electric conductivity. The thickness of the anode collector 22a is preferably, for example, about 6 μm to 40 μm. If the thickness is smaller than 6 μm, mechanical strength is insufficient, the anode collector 22a is easily torn in a manufacturing process, and production efficiency deteriorates. If the thickness is larger than 40 μm, the volume ratio of the anode collector 22a in the battery becomes high more than necessary, and it becomes difficult to increase energy density.

The anode mixture layer 22b contains one of or two or more of anode materials capable of inserting and extracting lithium as a light metal and may contain, as necessary, a binder similar to that in the cathode mixture layer 21b. The thickness of the anode mixture layer 22b is, for example, 60 μm to 250 μm. When the anode mixture layer 22b is provided on both faces of the anode collector 22a, the thickness is total thickness.

Insertion and extraction of a light metal in the specification denotes that ions of a light metal are electrochemical inserted and extracted without loosing ionicity. This includes not only a case where an inserted light metal exists in a perfect ion state but also a case where the inserted light metal exists in a state which cannot be as a perfect ion state. As examples of such cases, insertion by an electrochemical intercalation reaction of a light metal ion with graphite, insertion of a light metal by an alloy containing an intermetallic compound, and an insertion of a light metal by formation of an alloy can be also mentioned.

As anode materials capable of inserting and extracting lithium, for example, carbon materials such as graphite, graphitizing carbon, and non-graphitizable carbon can be mentioned. These carbon materials are preferable since a change in a crystal structure which occurs at the time of charge/discharge is very small, and large charge/discharge capacity and excellent charge/discharge characteristic can be obtained. Particularly, graphite is preferable since an electrochemical equivalent is large and high energy density can be obtained.

Graphite having true density of 2.10 g/cm³ or higher is preferable and graphite having true density of 2.18 g/cm³ or higher is more preferable. To obtain such true density, the thickness of a c-axis crystallite of the (002) plane has to be 14.0 nm or more. The spacing between (002) planes is preferably less than 0.340 nm and, more preferably, in a range from 0.335 nm to 0.337 nm.

The graphite may be natural graphite or artificial graphite. Artificial graphite is obtained by, for example, carbonizing an organic material, performing high-temperature heat treatment, and grinding and classifying the material. The high-temperature heat treatment is performed by, for example, as necessary, carbonizing a material in an inert gas air current of nitrogen (N₂) or the like at 300° C. to 700° C., increasing the temperature to 900° C. to 1500° C. at a rate of 1° C. to 100° C. per minute, calcinating the material while holding the temperature for about 0 to 30 hours, increasing the temperature to 2000° C. or higher, preferably, 2500° C. or higher and maintaining the temperature for proper time.

As an organic material which is a starting material, coal or pitch can be used. Examples of the pitch are pitches obtained by performing distillation (vacuum distillation, atmosphere distillation, or steam distillation), thermal polycondensation, extraction, and chemical polycondensation on tars, asphalt, or the like obtained by cracking coal tar, ethylene bottom oil, crude oil, or the like at high temperature, pitches generated at the time of wood recycle, polyvinyl chloride resin, polyvinyl acetate, polyvinyl butyrate, and 3,5-dimethyl phenol resin. Each of the coals and pitches exists as liquid at the maximum temperature of about 400° C. during carbonization and is held at that temperature, thereby making aromatic rings condensed and polycyclic to achieve a stacked oriented state. After that, at temperature of about 500° C. or higher, a solid carbon precursor, that is, semi-coke is obtained (liquid phase carbonization process).

As organic materials, condensed polycyclic carbonized hydrides such as naphtalene, phenanthrene, anthracene, triphenylene, pyrene, perylene, pentaphene, and pentacen, their derivatives (for example, carboxylic acid, carboxylic acid anhydride, and carboxylic acid imide), and mixtures of them can be used. Further, condensed heterocyclic compounds such as acenaphthylene, indole, isoindole, quinoline, isoquinoline, quinoxaline, phthalazine, carbazole, acridine, phenazine, and phenanthridine, their derivatives, and mixtures can be also used.

The grinding may be performed before or after carbonization or calcination or during the temperature increasing process before graphitization. In this case, finally, heat treatment for graphitization is performed on the material in a powder state. In order to obtain graphite powders of high bulk density and breaking strength, it is preferable to mold a material, perform heat treatment and grind and classify an obtained graphitized compact.

For example, in the case of fabricating a graphitized compact, chokes serving as fillers and a binder pitch serving as a binder or sintering agent are mixed and molded. After that, a firing process of performing heat treatment on the molding at a low temperature equal to or lower than 1000° C. and a pitch impregnating process of impregnating the fired body with a fused binder pitch are repeated a few times, and the resultant is subjected to heat treatment at high temperature. The impregnated binder pitch is carbonized by the heat treatment process and graphitized. Since the fillers (chokes) and the binder pitch are used as materials in this case, a polycrystalline substance is obtained by graphitization and sulfur and nitrogen contained in the material is generated as gas at the time of heat treatment, so that pores are formed in the path of the gas. There are advantages that the pores facilitate progress of insertion and extraction reactions of lithium and the industrial processing efficiency is high. As the material of the molded body, fillers having moldability and sinterbility may be used. In this case, it is unnecessary to use binder pitch.

Preferable non-graphitizable carbon is such that spacing between (002) planes is 0.37 nm or larger, true density is lower than 1.70 g/cm³, and a heat generation peak does not appear at 700° C. or higher in differential thermal analysis (DTA) in air.

Such a non-graphitizable carbon is obtained by, for example, performing heat treatment on an organic material at about 1200° C. and grinding and classifying the resultant. The heat treatment is carried out by, for example, carbonizing the material at 300° C. to 700° C. (solid phase carbonizing process) as necessary, increasing the temperature to 900° C. to 1300° C. at a rate of 1° C. to 100° C. per minute, and holding the temperature for about 0 to 30 hours. The grinding may be performed before or after carbonization or during the temperature increasing process.

As an organic material as a starting material, for example, a polymer or copolymer of furfuryl alcohol or furfural, or a furan resin as a copolymer of any of the high polymers and another resin can be used. A phenol resin, acrylic resin, halogenated vinyl resin, polyimide resin, polyamideimide resin, polyamide resin, a conjugated resin of polyacetylene, polyparaphenyn, or the like, cellulose or its derivative, coffee beans, bamboo, crustacea including chitosan, or biocellulose using bacteria can be also used. Further, a compound obtained by introduction (oxygen crosslink) of a functional group containing oxygen (O) into petroleum pitch of which atomic number ratio H/C. between hydrogen atoms (H) and carbon atoms (C) is, for example, 0.6 to 0.8 can be also used.

The content of oxygen in the compound is preferably 3% or higher and, more preferably, 5% or higher (refer to Japanese Patent Laid-open No. Hei 3-252053). The content of oxygen exerts an influence on a crystal structure of a carbon material, properties of the non-graphitizable carbon can be improved at the content or higher, and the capacity of the anode 22 can be increased. The petroleum pitch can be obtained by performing distillation (vacuum distillation, atmosphere distillation, or steam distillation), thermal polycondensation, extraction, and chemical polycondensation on tars obtained by cracking coal tar, ethylene bottom oil, crude oil, or the like, asphalt or the like at high temperature. As an oxygen crosslink forming method, for example, a wet method for making a solution of nitric acid, sulfuric acid, hypochlorous acid or mixed acid react with petroleum pitch, a dry method of making oxidation gas such as air or oxygen react with petroleum pitch, or a method of making a solid reagent such as sulfur, ammonium nitrate, ammonia persulfate, or ferric chloride react with petroleum pitch can be used.

The organic materials as starting materials are not limited to the above-described materials. Another organic material can be used as long as it can become non-graphitizable carbon by a solid-phase carbonizing process such as an oxygen crosslink process.

Except for the non-graphitizable carbon manufactured by using any of the above-described organic materials as a starting material, a compound containing, as main components, phosphorous (P), oxygen, and carbon disclosed in Japanese Patent Laid-open No. Hei 3-137010 is also preferable since it exhibits the above-described physical parameters.

As anode materials capable of inserting and extracting lithium, a simple body, alloy, or compound of a metal element or metalloid which can form an alloy in cooperation with lithium can be mentioned. Those materials are preferable since they can obtain high energy density. Particularly, it is more preferable to use any of the materials together with a carbon material since high energy density and excellent charge/discharge cycle characteristic can be obtained. In the specification, alloys include an alloy consisting of two or more metal elements and, in addition, an alloy consisting of one or more metal elements and one or more metalloids. In the structure of each of the materials, solid solution, eutectic (eutectic mixture), or intermetallic compound exists or two or more of them coexist.

Examples of such metal elements or metalloids are tin (Sn), lead (Pb), aluminum, indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), and hafnium (Hf). An alloy or compound of any of the elements is expressed by, for example, a chemical formula of MaₛMbₜLiᵤ or MaₚMc_{q}Mdᵣ. In the chemical formulae, Ma indicates at least one kind of metal elements and metalloids capable of forming an alloy in cooperation with lithium, Mb denotes at least one of metal elements and metalloids other than lithium and Ma, Mc indicates at least one of non-metallic elements, and Md indicates at least one of metal elements and metalloids other than Ma. The values of s, t, u, p, q, and r satisfy s>0, t24 0, u24 0, p>0, q>0, and r24 0, respectively.

Specially, a simple substance, alloy, or compound of a group 4B metal element or metalloid is preferable. Particularly preferable elements are silicon and tin and their alloys and compounds. The materials may be crystalline or amorphous ones.

Concrete examples of the alloys and compounds are LiAl, AlSb, CuMgSb, SiB₄, SiB₆, Mg₂Si, Mg₂Sn, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), SnO_{w} (0<w≦2), SnSiO₃, LiSiO, and LiSnO.

Examples of anode materials capable of inserting and extracting lithium are other metal compounds and high molecular weight materials. The other metal compounds include oxides such as iron oxide, ruthenium oxide, and molybdenum oxide, LiN₃, and the like. The high molecular weight materials include polyacetylene, polyaniline, and polypyrrole, and the like.

In the secondary battery, in a charging process, at the time point when an open circuit voltage (that is, battery voltage) is lower than overcharge voltage, the lithium metal starts precipitating on the anode 22. Specifically, in a state where the open circuit voltage is lower than the overcharge voltage, the lithium metal is deposited on the anode 22 and the capacity of the anode 22 is expressed by the sum of a capacity component determined by insertion and extraction of lithium and a capacity component determined by deposition and dissolution of the lithium metal. In the secondary battery, therefore, both the anode material capable of inserting/extracting lithium and the lithium metal function as anode activate materials, and the anode material capable of inserting and extracting lithium serves as a base material at the time of deposition of the lithium metal.

The overcharge voltage indicates an open circuit voltage when a battery is in an overcharged state and is, for example, a voltage higher than the open circuit voltage of the battery which is “completely charged” described and defined in “safety evaluation reference guideline of lithium secondary batteries” (SBA G1101) as one of guidelines determined by Battery Association of Japan. In other words, the overcharge voltage is a voltage higher than an open circuit voltage obtained after charging is performed according to a charging method used at the time of obtaining nominal capacity of a battery, a standard charging method, or a recommended charging method. Concretely, for example, when an open circuit voltage is 4.2 V, the secondary battery is completely charged. In a part of the range from 0 V to 4.2 V of the open circuit voltage, a lithium metal is deposited on the surface of the anode material capable of inserting/extracting lithium.

Therefore, the secondary battery can obtain high energy density and improved cycle characteristic and quick charge/discharge characteristic. Although the secondary battery is similar to the conventional lithium secondary battery using a lithium metal or lithium alloy for the anode from the point that the lithium metal is deposited on the anode 22, by making the lithium metal deposited on the anode material capable of inserting/extracting lithium, the following advantages are considered to be created.

First, in the conventional lithium secondary battery, it is difficult to make the lithium metal uniformly deposited, and it causes deterioration in the cycle characteristic. However, since the surface area of the anode material capable of inserting/extracting lithium is generally large, the lithium metal can be uniformly deposited in the secondary battery. Second, in the conventional lithium secondary battery, a volume changes largely in association with deposition and dissolution of the lithium metal and it causes deterioration in the cycle characteristic. In contrast, in the secondary battery, the lithium metal is deposited also in the gap between particles of the anode material capable of inserting/extracting lithium, so that the volume change is little. Third, in the conventional lithium secondary battery, the larger the deposition/dissolution amount of the lithium metal is, the bigger the above-described problem becomes. In the secondary battery, however, the insertion and extraction of lithium by the anode material capable of inserting/extracting lithium also contributes to the charge/discharge capacity. Consequently, although the battery capacity is large, the deposition/dissolution amount of the lithium metal is small. Fourth, in the conventional lithium secondary battery, when quick charging is performed, the lithium metal is deposited more nonuniformly, so that the cycle characteristic deteriorates more. In the secondary battery, however, in the beginning of charging, the lithium is inserted in the anode material capable of inserting/extracting the lithium, so that quick charging is realized.

To obtain the advantages more effectively, for example, when the open circuit voltage is the maximum voltage before it becomes the overcharge voltage, the maximum deposition amount of the lithium metal deposited on the anode 22 is preferably 0.05 to 3.0 times as large as the charging capacity of the anode material capable of inserting/extracting lithium. When the amount of deposition of the lithium metal is too large, problems similar to those of the conventional lithium secondary battery occur. When it is too small, a sufficiently large charge/discharge capacity cannot be achieved. For example, the discharge capacity of the anode material capable of inserting/extracting lithium is preferably 150 mAh/g or larger. The larger the inserting/extracting capacity of lithium is, the more the deposition amount of the lithium metal becomes relatively smaller. The charge capacity of the anode material can be obtained from, for example, quantity of electricity at the time of charging the anode made of an anode active material to 0 V according to a constant current and constant voltage method when the lithium metal is used for a counter electrode. The discharging capacity of the anode material is obtained from, for example, quantity of electricity at the time of discharging the anode for ten or more hours by a constant current method to 2.5 V.

The separator 23 is formed of, for example, a porous film made of a synthetic resin such as polytetrafluoroethylene, polypropylene, or polyethylene or a porous film made of ceramics. The separator 23 may have a structure in which two ore more kinds of porous films are laminated. Particularly, a porous film made of polyolefine is preferable since it has excellent short-circuiting preventing effect and realizes improved safety of the battery by its shut-down effect. Particularly, polyethylene can obtain the shut-down effect in the range from 100° C. to 160° C. and also has electrochemical stability, so that it is preferable as the material of the separator 23. Polypropylene is also preferable. Any resin having chemical stability can be used by being copolymerized or blended with polyethylene or polypropylene.

The porous film made of polyolefine is obtained by, for example, mixing a low-volatile solvent in a fused liquid state with a polyolefine composition in a fused state to obtain a high-concentration solution of a uniform polyolefine composition, molding the solution in a die, cooled the solution to thereby obtain a gel sheet, and drawing the gel sheet.

As the low-volatile solvent, for example, a low-volatile fatty series such as nonane, decane, decalin, p-xylene, undecane, or a liquid paraffin, or a cyclic hydrocarbon can be used. As a preferable mix proportion between the polyolefine composition and the low-volatile solvent, when total of them is 100 wt %, the polyolefine composition is in a range from 10 to 80 wt %, more preferably, from 15 to 70 wt %. When the proportion of the polyolefine composition is too low, swelling occurs at the outlet of the die at the time of molding or neck-in becomes large, and it becomes difficult to form a sheet. On the other hand, when the proportion of the polyolefine composition is too high, it becomes difficult to prepare a uniform solution.

At the time of molding a high-concentration solution of the polyolefine composition by using a die, in the case of a sheet die, a gap is preferably, for example, in a range from 0.1 mm to 5 mm. Preferably, extrusion temperature lies in a range from 140° C. to 250° C., and extrusion speed lies in a range from 2 cm/minute to 30 cm/minute.

Cooling is performed at least to a gelation temperature. As a cooling method, a method of making the solution come into direct contact with cold blast, cooling water, or other cooling media, a method of making the solution come into contact with a roll cooled with a refrigerant, and the like can be used. The high-density solution of the polyolefine composition extruded from the die may be taken off at a take-off rate of 1 to 10, preferably, 1 to 5 before or during the cooling. When the take-off rate is too high, it is unpreferable since neck-in becomes large and fracture easily occurs at the time of drawing.

It is preferable to draw the gel sheet by, for example, a method of heating the gel sheet and biaxially drawing it by a tenter method, a rolling method, a drawing method or a method obtained by combining any of the methods. The gel sheet may be drawn simultaneously in the vertical and horizontal directions or sequentially. Particularly, simultaneously two-dimensional drawing is preferable. The drawing temperature is preferably a temperature obtained by adding ten degrees to the melting point of the polyolefine composition or less, more preferably, a temperature equal to or higher than a crystal dispersion temperature and lower than a melting point. If the drawing temperature is too high, it is not preferable since effective molecular chain orientation by drawing cannot be realized due to fusion of the resin. If the drawing temperature is too low, softening of the resin becomes insufficient, so that the film of the resin is easily broken at the time of drawing, and drawing at high scaling cannot be performed.

It is preferable to draw the gel sheet and clean the drawn sheet with a volatile solvent to remove the residual low-volatile solvent. After the cleaning, the drawn film is dried by heating or blast so as to volatilize the cleaning solvent. Examples of the cleaning solvent are volatilizing solvents which are hydrocarbon such as pentane, hexane, or heptane, methylene chloride, chlorinated hydrocarbon such as carbon tetrachloride, fluorocarbon such as ethane trifluoride, and ethers such as diethyl ether and dioxane. A cleaning solvent is chosen according to the used low-volatile solvent and a single solvent or a mixture of some solvents is used. The cleaning is performed by a method of impregnating the sheet with the volatile solvent and pulling it out, a method of dusting the volatile solvent, or a method as a combination of those methods. The cleaning is performed until the residual low-volatile solvent in the drawn film becomes less than 1 part by mass with respect to 100 parts by mass of the polyolefine composition.

The separator 23 is impregnated with an electrolyte solution which is a liquid-state electrolyte. The electrolyte solution contains a nonaqueous solvent which is a liquid solvent such as an organic solvent and a lithium salt as an electrolyte salt dissolved in the nonaqueous solvent. The liquid nonaqueous solvent is made of, for example, a nonaqueous compound of which intrinsic viscosity at 25° C. is 10.0 mPa·s or less. A nonaqueous component of which intrinsic viscosity in a state where the electrolyte salt is dissolved is 10.0 mPa·s or less may be also used. In the case of forming a solvent by mixing a plurality of kinds of nonaqueous compounds, it is sufficient that the intrinsic viscosity in the mixed state is 10.0 mPa·s or less.

As such a nonaqueous solvent, various nonaqueous solvents conventionally used can be employed. Concretely, cyclic ester carbonate such as propylene carbonate or ethylene carbonate, chain ester such as ester carbonate, diethyl carbonate, dimethyl carbonate, or ethylmethyl carbonate, ether such as γ-butyrolactone, sulfolane, 2-methyltetrahydrofuran, or dimethoxyethane can be mentioned. Particularly, from the viewpoint of oxidation stability, it is preferable to mix ester carbonate in a nonaqueous solvent.

Examples of the lithium salt are LiAsF₆, LiPF₆, LiBF₄, LiClO₄, LiB(C₆H₅)₄, LiCH₃SO₃, LiCF₃SO₃, LiN(CF₃SO₂)₂, LiN(C₂F₅SO₂)₂, LiN(C₄F₉SO₂)(CF₃SO₂), LiC(CF₃SO₂)₃, LiAlCl₄, LiSiF₆, LiCl and LiBr. Any one of them or a mixture of two or more of them may be used.

Particularly, LiPF₆ is preferable since it has high conductivity and excellent oxidation stability. LiBF₄ is preferable since it has excellent thermal stability and oxidation stability. LiCF₃SO₃ is preferable since it has high thermal stability. LiClO₄ is preferable since it has high conductivity. Further, LiN(CF₃SO₂)₂, LiN(C₂F₅SO₂)₂, and LiC(CF₃SO₂)₃ are preferable since they can obtain relatively high conductivity and high thermal stability. Further, it is more preferable to use a mixture of at least two kinds of the above lithium salts since effects of them can be obtained. Particularly, it is preferable to use a mixture of at least one kind selected from a group of lithium salts such as LiN(CF₃SO₂)₂, LiN(C₂F₅SO₂)₂, and LiC(CF₃SO₂)₃ having the molecular structure expressed by Chemical Formula 1 and one or more lithium salts other than the lithium salts having the molecular structure expressed by Chemical Formula 1 since high conductivity can be obtained and chemical stability of the electrolyte solution can be improved. In the other lithium salts, LiPF₆ is particularly preferable.

(CₐF_{b}SO_{c})_{d} [Chemical Formula 1]

wherein each of a, b, c, and d expresses an arbitrary number other than 0.

The content (concentration) of each of the lithium salts in a solvent is preferably in a range from 0.5 mol/kg to 3.0 mol/kg. It is feared that ion conductivity deteriorates extremely out of the range and sufficient battery characteristics cannot be obtained.

The electrolyte solution contains, as an additive, at least one of carboxylate ester and carboxylate ion. The carboxylate ester is discomposed to become a radical compound at the time of charging and positively adsorbed or polymerized in a radical active site of the anode 22 to thereby form a film. The carboxylate ester has, therefore, the functions of suppressing a decomposition reaction of the solvent at the radical active site of the anode 22 and preventing a reaction between the lithium metal deposited in the deposition/dissolution reaction of the lithium and the solvent. Further, as reported by Osaka et al., “J. Electrochem. Soc.”, Vol. 142, No. 4, 1995, the carboxylate ester also has the function of improving efficiency of deposition/dissolution of lithium in the anode 22 by carbon dioxide (CO₂) generated by decomposition. The carboxylate ion also has similar functions.

By containing such carboxylate ester or carboxylate ion, the secondary battery can have improved battery capacity and cycle characteristic. Although each of carboxylate ester and carboxylate ion can function as a solvent, by paying attention to the above-described functions, in the specification, each of carboxylate ester and carboxylate ion is described as an additive. Obviously, it is sufficient that at least part of the added material contributes to the reaction as described above. The part which does not contribute to the reaction may function as a solvent.

Examples of the carboxylate ester are methyl propionate, butyl propionate, methyl butyrate, ethyl acetate, ethyl valerate, and a material obtained by substituting a part or all of hydrogen in any of the above materials with fluorine (F). An example of the carboxylate ion is an ion dissociated from carboxylic acid ester. Particularly, carboxylate ester expressed by the following Chemical Formula 2 such as methyl propionate, methyl butyrate, or ethyl acetate and carboxylate ions as ions dissociated from carboxylate ester expressed by Chemical Formula 2 are preferable. To realize the function of suppressing decomposition reaction of the solvent or the function of preventing reaction between a deposited lithium metal and a solvent, a steric hindrance of a certain magnitude is necessary. However, when the steric hindrance is too large, film resistance in the surface of the anode 22 increases more than necessary and discharge capacity decreases.

CₘHₓF₂ₘ₊₁₋ₓ—COO—CₙH_{y}F_{2n+1-y} [Chemical Formula 2]

wherein each of m and n indicates an integer from 1 to 3, and each of x and y denotes an integer from 0 to 7.

The content (concentration) of carboxylate ester or carboxylate ions, which is a total of contents when two or more kinds are contained, is preferably in a range from 0.005 wt % to 30 wt % in the total of the solvent and the electrolyte salt. If the content is lower than 0.005 wt %, sufficient effects are not obtained. If the content is higher than 30 wt %, there is the possibility that the battery deteriorates when stored.

A gel electrolyte in which an electrolyte solution is held in a high molecular weight compound may be used in place of an electrolyte solution. The ion conductivity of the gel electrolyte may be 1 mS/cm or higher at room temperature and the composition and the structure of a high molecular weight compound are not particularly limited. The electrolyte solutions (that is, liquid-state solutions, electrolyte salts, and additives) are as described above. Examples of the high molecular weight compounds are polyacrylonitrile, polyvinylidene fluoride, a copolymer between polyvinylidene fluoride and polyhexafluoropropylene, polytetrafluoroethylene, polyhexafluoropropylene, polyethylene oxide, polypropylene oxide, polypohosphagen, polysiloxane, polyvinyl acetate, polyvinyl alcohol, polymethyl methacrylate, polyacrylic acid, polymethacrylic acid, styrene-butadiene rubber, nitrile-butadiene rubber, polystylene, and polycarbonate. Particularly, from the viewpoint of electrochemical stability, it is desirable to use a high molecular weight compound having the structure of polyacrylonitrile, polyvinylidene fluoride, polyhexafluoropropylene, or polyethylene oxide. An addition amount of the high molecular weight compound to the electrolyte solution is, though it varies according to compatibility between them, usually 5 wt % to 50 wt % of the electrolyte solution.

The contents of carboxylate ester and carboxylate ion, and lithium salt are similar to those in the case of an electrolyte solution. The concept of a solvent here widely includes not only a liquid-state solvent but also a solvent capable of dissociating an electrolyte salt and having ion conductivity. Therefore, in the case of using a high molecular weight compound having ion conductivity, the high molecular weight compound is also included in the solvent.

For example, this secondary battery can be produced as follows.

First, for instance, a cathode mixture is prepared by mixing the cathode material capable of inserting and extracting lithium, a conductive agent, and a binder. The cathode mixture is dispersed in a solvent of N-methyl-2-pyrrolidone or the like to thereby obtain a cathode mixture slurry in a paste state. The cathode mixture slurry is applied on the cathode collector 21a, dried, and compression molded by a roller press or the like, thereby forming the cathode mixture layer 21b. In such a manner, the cathode 21 is fabricated.

Subsequently, for example, an anode material capable of inserting and extracting lithium and a binder are mixed to prepare an anode mixture. The anode mixture is dispersed in a solvent of N-methyl-2-pyrrolidone or the like to thereby obtain an anode mixture slurry in a paste state. The anode mixture slurry is applied on the anode collector 22a, dried, and compression molded by a roller press or the like, thereby forming the anode mixture layer 22b. In such a manner, the anode 22 is fabricated.

Subsequently, the cathode lead 25 is attached to the cathode collector 21a by welding or the like, and the anode lead 26 is attached to the anode collector 22a by welding or the like. After that, the cathode 21 and the anode 22 are rolled sandwiching the separator 23 in between, the tip of the cathode lead 25 is welded to the safety valve mechanism 15, the tip of the anode lead 26 is welded to the battery can 11, and the rolled cathode 21 and anode 22 are sandwiched by the pair of insulating plates 12 and 13 and enclosed in the battery can 11. After the cathode 21 and the anode 22 are enclosed in the battery can 11, the electrolyte is injected into the battery can 11 and the separator 23 is impregnated with the electrolyte. The battery cover 14, the safety valve mechanism 15, and the PTC device 16 are fixed to the open end of the battery can 11 via the gasket 17 by caulking. In such a manner, the secondary battery shown in FIG. 1 is formed.

The secondary battery acts as follows.

When the secondary battery is charged, lithium ions are extracted from the cathode mixture layer 21b and inserted in the anode material capable of inserting/extracting lithium contained in the anode mixture layer 22b via the electrolytic solution with which the separator 23 is impregnated. When charging is continued, in a state where the open circuit voltage is lower than the overcharge voltage, the charge capacity exceeds the charge capacity of the anode material capable of inserting/extracting lithium, and the lithium metal starts to be deposited on the surface of the anode material. After that, until the charging is finished, the lithium metal continues to be deposited on the anode 22. In the case of using, for example, graphite as the anode material capable of inserting/extracting lithium, the appearance of the anode mixture layer 22b changes from black to golden color and, further, to silver color.

After that, when the secondary battery is discharged, first, the lithium metal deposited on the anode 22 is released as ions and inserted in the cathode mixture layer 21b via the electrolytic solution with which the separator 23 is impregnated. When discharging is continued, the lithium ions inserted in the anode material capable of inserting/extracting lithium in the anode mixture layer 22b are extracted and inserted in the cathode mixture layer 21b via the electrolyte. Therefore, the secondary battery can obtain the characteristics of both of the conventional so-called lithium secondary battery and the lithium ion secondary battery, specifically, high energy density and excellent charge/discharge cycle characteristic.

Particularly, in the embodiment, at least one of carboxylate ester and carboxylic ion is contained. Consequently, at the time of charging, the radical compound of carboxylate ester is positively adsorbed or polymerized in a radical active site of the anode 22, thereby forming a film. It suppresses decomposition reaction of the solvent in the radical active site of the anode 22. Since it is considered that the film is a fine film having lithium ion conductivity, the deposition/dissolution reaction of lithium occurs below the film, and the reaction between the lithium metal and the solvent is prevented by the film. Further, a part of the radical compound in carboxylate ester is gradually decomposed, thereby generating carbon dioxide. The carbon dioxide is dissolved in the electrolyte, so that the lithium metal is smoothly deposited on the anode 22. Thus, the deposition/dissolution reaction of the lithium metal is excellently repeated and, as a result, the deposition/dissolution efficiency of lithium is improved.

As described above, according to the embodiment, the electrolyte contains at least one of carboxylate ester and carbonic acid ions, so that a stable film can be formed on the surface of the anode 22 and the decomposition reaction of the solvent in the radical active site in the anode 22 can be suppressed. In the deposition/dissolution reaction of the lithium, the lithium metal can be deposited below the film, so that the reaction between the deposited lithium metal and the solvent can be prevented. Therefore, chemical stability of the electrolyte can be improved. Further, by decomposition of carboxylate ester or carboxylate ions, carbon dioxide can be dissolved in the electrolyte, the lithium metal can be smoothly deposited on the anode 22, and the deposition/dissolution efficiency of lithium can be improved. Therefore, the battery characteristics such as battery capacity and cycle characteristic can be improved.

Further, when carboxylate ester expressed by Chemical Formula 2 and carboxylate ions dissociated from the carboxylate ester are contained, or when the content of carboxylate ester and carboxylate ions is set in the range from 0.005 wt % to 30 wt % in the total of the solvent and the electrolyte salt, higher effects can be obtained.

### EXAMPLES

Further, concrete examples of the invention will be described in detail with reference to FIGS. 1 and 2.

### Examples 1 to 4

An area density ratio between the cathode 21 and the anode 22 was adjusted and a battery in which the capacity of the anode 22 is expressed by the sum of a capacity component determined by insertion and extraction of lithium and a capacity component determined by deposition and dissolution of lithium was fabricated.

First, lithium carbonate (Li₂CO₃) and cobalt carbonate (CoCO₃) were mixed at a mole ratio of (Li₂CO₃):(CoCO₃)=0.5:1. The mixture was fired at 900° C. for 5 hours in the air, thereby obtaining a lithium/cobalt composite oxide (LiCoO₂) as a cathode material. Subsequently, 91 parts by mass of the lithium/cobalt composite oxide, 6 parts by mass of graphite as a conductive agent, and 3 parts by mass of polyvinylidene fluoride as a binder were mixed, thereby preparing a cathode mixture. After that, the cathode mixture was dispersed in N-methyl-2-pyrrolidone as a solvent, thereby obtaining a cathode mixture slurry. The cathode mixture slurry was uniformly applied on both sides of the cathode collector 21a made of aluminum foil in a strip shape having a thickness of 20 μm, dried, and compression molded by a roller press, thereby forming the cathode mixture layer 21b and fabricating the cathode 21. After that, the cathode lead 25 made of aluminum was attached to one end of the cathode collector 21a.

Artificial graphite powders were prepared as an anode material, and 90 parts by mass of the artificial graphite powders and 10 parts by mass of polyvinylidene fluoride as a binder were mixed, thereby preparing an anode mixture. The anode mixture was dispersed in N-methyl-2-pyrrolidone as a solvent to obtain an anode mixture slurry. After that, the anode mixture slurry was uniformly applied on both sides of the anode collector 22a made of copper foil in a strip shape having a thickness of 10 μm, dried, and compression molded by a roller press, thereby forming the anode mixture layer 22b and fabricating the anode 22. After that, the anode lead 26 made of nickel was attached to one end of the anode collector 22a.

After fabricating the cathode 21 and the anode 22, the separator 23 made by a microporous polypropylene film having a thickness of 25 μm was prepared. The anode 22, separator 23, cathode 21, and separator 23 were stacked in this order and the stacked body was rolled a number of times in a scroll shape to thereby form the rolled electrode body 20.

After fabricating the rolled electrode body 20, the rolled electrode body 20 was sandwiched by a pair of insulating plates 12 and 13, the anode lead 26 was welded to the battery can 11, the cathode lead 25 was welded to the safety valve mechanism 15, and the rolled electrode body 20 was enclosed in the battery can 11 made of iron plated with nickel. After that, an electrolytic solution was injected into the battery can 11 by a low pressure manner. The electrolytic solution was obtained by adding methyl propionate expressed by Chemical Formula 2 in which m=2 and n=1 to a solvent obtained by mixing LiPF₆ as an electrolyte salt into a solvent in which 50 vol % of ethylene carbonate and 50 vol % of diethyl carbonate were mixed at a concentration of 1 mol/dm³. At this time, the content of methyl propionate to the total of the solvent and the electrolyte salt was changed as shown in Table 1 in Examples 1 to 4.

TABLE 1

| | Additive | | | | | Discharge | |
|---|---|---|---|---|---|---|---|
| | | | | Con- | Initial | capacity | |
| | | Compo- | | tent | dis- | of the | Deposition |
| | | sition | | (wt | charge | 100th | of Li |
| | Kind | m | n | %) | capacity | cycle | metal |
| Example 1 | methyl | 2 | 1 | 0.05 | 101 | 101 | deposited |
| | propionate | | | | | | |
| Example 2 | methyl | 2 | 1 | 2 | 104 | 111 | deposited |
| | propionate | | | | | | |
| Example 3 | methyl | 2 | 1 | 10 | 103 | 111 | deposited |
| | propionate | | | | | | |
| Example 4 | methyl | 2 | 1 | 30 | 101 | 103 | deposited |
| | propionate | | | | | | |
| Compar- | — | 0 | 0 | 0 | 100 | 100 | deposited |
| ative | | | | | | | |
| Example 1 | | | | | | | |
| Compar- | methyl | 2 | 1 | 2 | 101 | 100 | not |
| ative | propionate | | | | | | deposited |
| Example 2 | | | | | | | |
| Compar- | — | 0 | 0 | 0 | 100 | 100 | not |
| ative | | | | | | | deposited |
| Example 3 | | | | | | | |

The electrolyte solution was injected into the battery can 11 and the battery cover 14 was fixed to the battery can 11 by caulking via the gasket 17 on which asphalt was applied, thereby obtaining cylindrical secondary batteries having a diameter of 14 mm and a height of 65 mm of Examples 1 to 4.

As Comparative Example 1 to be compared with Examples, except that methyl propionate was not added to the electrolyte solution, a secondary battery was fabricated in a manner similar to Examples. Further, as Comparative examples 2 and 3 to be compared with Examples, the area density ratio between the cathode and the anode was adjusted, and lithium ion secondary batteries in which the capacity of the anode is expressed by insertion and extraction of lithium were fabricated. In Comparative Example 2, methyl propionate of the content of 2 wt % with respect to total of the solvent and the electrolyte salt was added to the electrolyte solution. In Comparative Example 3, methyl propionate was not added to the electrolyte solution.

A charge/discharge test was conducted on the obtained secondary batteries of Examples 1 to 4 and Comparative Examples 1 to 3 to obtain the discharge capacity of the first cycle, that is, the initial discharge capacity, and the discharge capacity of the 100th cycle. Charging was performed until the battery voltage reached 4.2 V with a constant current of 600 mA and the current reached 1 mA with a constant voltage of 4.2 V. Discharging was performed until the battery voltage reached 3.0 V with a constant current of 400 mA. When the charging/discharging is performed under the conditions, a complete charged state and a complete discharged state are set. Table 1 shows the results. In Table 1, the initial discharge capacity of each of Examples 1 to 4 is a relative value when the initial discharge capacity of Comparative Example 1 is set to 100. The discharge capacity of the 100th cycle of each of Examples 1 to 4 is a relative value when the discharge capacity of the 100th cycle of Comparative Example 1 is set to 100. The initial discharge capacity of Comparative Example 2 is a relative value when the initial discharge capacity of Comparative Example 3 is set to 100. The discharge capacity of the 100th cycle of Comparative Example 2 is a relative value when the discharge capacity of the 100th cycle of Comparative Example 3 is set to 100.

Each of the secondary batteries of Examples 1 to 4 and Comparative Examples 1 to 3, which was charged and discharged in one cycle under the above-described conditions and completely charged again was decomposed. A check was made to see whether the lithium metal was deposited on the anode mixture layer 22b or not by visual observation and by ⁷Li nuclear magnetic resonance spectrome. Further, the charging and discharging was performed two cycles under the above-described conditions. The completely discharged secondary battery was decomposed and a check was similarly made to see whether the lithium metal was deposited on the anode mixture layer 22b or not.

As a result, in the secondary batteries of Examples 1 to 4 and Comparative Example 1, the existence of the lithium metal was recognized in the anode mixture layer 22b in the completely charged state and the existence of the lithium metal was not recognized in the completely discharged state. That is, it was confirmed that the capacity of the anode 22 is expressed by the sum of the capacity component determined by deposition/dissolution of the lithium metal and the capacity component determined by insertion/extraction of the lithium. Table 1 shows that the lithium metal was “deposited” as the result.

On the other hand, in the secondary batteries of Comparative Examples 2 and 3, the existence of the lithium metal was not recognized in both of the complete charge state and the complete discharge state but only the existence of the lithium ion was recognized. The peak belonging to the lithium ion recognized in the complete discharge state was very small. That is, it was confirmed that the capacity of the anode is expressed by the capacity component determined by insertion/extraction of the lithium. In Table 1, it was described that the lithium metal was “not deposited” as the result.

As understood from Table 1, in Examples 1 to 4 in which methyl propionate was added, as the initial discharge capacity and the discharge capacity of the 100th cycle, higher values as compared with Comparative Example 1 in which methyl propionate was not added could be obtained. In Comparative Examples 2 and 3 of the lithium ion secondary batteries, the initial discharge capacity of Comparative Example 2 in which methyl propionate was added was slightly higher than that of Comparative Example 3 in which methyl propionate was not added. However, there is no difference with respect to the discharge capacity of the 100th cycle. That is, it is understood that, in the secondary battery in which the capacity of the anode 22 is expressed by the sum of the capacity component determined by insertion and extraction of a light metal and the capacity component determined by deposition and dissolution of a light metal, when the electrolyte solution contains methyl propionate, the discharge capacity and the charge/discharge cycle characteristic can be improved.

From the results of Examples 1 to 4, the tendency was observed such that, as the content of methyl propionate is increased, the initial discharge capacity and the discharge capacity of the 100th cycle increase, exhibit the maximum values and, after that, decrease. That is, it was understood that higher effects can be obtained when the content of methyl propionate is set in the range from 0.005 wt % to 30 wt % of the total of the solvent and the electrolyte salt.

### Examples 5 to 7

Secondary batteries were fabricated in a manner similar to Example 2 except that methyl butyrate in which m=3 and n=1 in Chemical Formula 2, butyl propionate in which m=2 and n=4, or ethyl acetate in which m=1 and n=2 was added in place of methyl propionate to an electrolyte solution. In Examples 5 to 7, a charge/discharge test was conducted in a manner similar to Example 2 and the initial discharge capacity and the discharge capacity of the 100th cycle were obtained. Table 2 shows the results together with the results of Example 2 and Comparative Example 1. In Table 2, the initial discharge capacity is a relative value when the initial discharge capacity of Comparative Example 1 is set to 100, and the discharge capacity of the 100th cycle is a relative value when the discharge capacity of the 100th cycle of Comparative Example 1 is set to 100.

TABLE 2

| | Additive | | | | | Discharge | |
|---|---|---|---|---|---|---|---|
| | | | | Con- | Initial | capacity | |
| | | Compo- | | tent | dis- | of the | Deposition |
| | | sition | | (wt | charge | 100th | of Li |
| | Kind | m | n | %) | capacity | cycle | metal |
| Example 2 | methyl | 2 | 1 | 2 | 104 | 111 | deposited |
| | propionate | | | | | | |
| Example 5 | methyl | 3 | 1 | 2 | 103 | 108 | deposited |
| | butyrate | | | | | | |
| Example 6 | butyl | 2 | 4 | 2 | 101 | 101 | deposited |
| | propionate | | | | | | |
| Example 7 | ethyl | 1 | 2 | 2 | 103 | 109 | deposited |
| | acetate | | | | | | |
| Compar- | — | 0 | 0 | 0 | 100 | 100 | deposited |
| ative | | | | | | | |
| Example 1 | | | | | | | |

As understood from Table 2, in Examples 5 to 7, as the initial discharge capacity and the discharge capacity of the 100th cycle, higher values are obtained as compared with Comparative Example 1. Particularly, remarkably excellent values were obtained in Examples 2, 5, and 7 in which the values of m and n are 3 or less. When carboxylate ester is contained in the electrolyte solution, the discharge capacity and the charge/discharge cycle characteristics can be improved. Particularly, by adding carboxylate ester expressed by Chemical Formula 2, it is understood that a higher effect can be obtained.

Concrete examples of carboxylate ester have been described in the examples. It is considered that the above-described effects are produced by the molecular structure of carboxylate ester. Therefore, also in the case of using other carboxylate esters, similar results can be obtained. Although the case of using the electrolyte solution has been described in the examples, similar effects can be also obtained by using a gel electrolyte.

Although the invention has been described by the embodiment and examples, the invention is not limited to the embodiment and examples but can be variously modified. For example, although the case of using lithium as a light metal has been described in the foregoing embodiment and examples, the invention can be also applied to cases of using other alkali metals such as sodium (Na) and potassium (K), alkaline earth metals such as magnesium and calcium (Ca), other light metals such as aluminum, and alloys of lithium or those metals, and similar effects can be obtained. At that time, the anode material, cathode material, nonaqueous solvent, electrolyte salt, and the like capable of inserting and extracting a light metal are selected according to the light metal. When lithium or an alloy containing lithium is used as a light metal, since voltage compatibility with a lithium ion secondary battery which is presently commercially available is high, it is preferable. In the case of using an alloy containing lithium as a light metal, a substance which can form an alloy in cooperation with lithium exists in the electrolyte, and an alloy may be formed at the time of deposition. A substance which can form an alloy in cooperation with lithium exists in the anode and an alloy may be formed at the time of deposition.

Although the case of using an electrolyte solution or a gel electrolyte as a kind of a solid electrolyte has been described in the foregoing embodiment and examples, other electrolytes may be used. Examples of the other electrolytes are an organic solid electrolyte in which an electrolyte salt is dispersed in a high molecular weight compound having ion conductivity, an inorganic solid electrolyte made of ionic conductive ceramics, ionic conductive glass, ionic crystal, or the like, a mixture of any of the inorganic solid electrolytes and an electrolyte solution, and a mixture of any of the inorganic solid electrolytes and a gel electrolyte or organic solid electrolyte.

Further, although the cylindrical secondary battery having a roll structure has been described in the foregoing embodiment and examples, the invention can be also similarly applied to a secondary battery of an oval shape or a polygonal shape having a rolled structure, and a secondary battery having a structure in which a cathode and an anode are folded or stacked. In addition, the invention can be also applied to a secondary battery of so-called a coin type, a button type, a rectangular shape, or the like. The invention is not limited to the secondary batteries but can be also applied to primary batteries.

As described above, in the battery according to the invention, the electrolyte contains at least one of carboxylate ester and carbonic acid ions, so that a stable film can be formed on the surface of the anode and the decomposition reaction of the solvent in the radical active site in the anode can be suppressed. In the deposition/dissolution reaction of a light metal, the light metal can be deposited below the film, so that the reaction between the deposited light metal and the solvent can be prevented. Therefore, chemical stability of the electrolyte can be improved. Further, by decomposition of carboxylate ester or carboxylate ions, carbon dioxide can be dissolved in the electrolyte, the light metal can be smoothly deposited on the anode, and the deposition/dissolution efficiency of the light metal can be improved. Therefore, the battery characteristics such as battery capacity and cycle characteristic can be improved.

Particularly, in the battery of one aspect of the invention, the electrolyte contains one of carboxylate ester expressed by Chemical Formula 2 or carboxylate ions dissociated from the carboxylate ester or content of the carboxylate ester and the carboxylate ions is set in a range from 0.005 wt % to 30 wt % with respect to a total of the solvent and the electrolyte salt. Thus, higher effects can be obtained.

Obviously many modifications and variations of the present invention are possible in the light of the above teachings. It is therefore to be understood that within the scope of the appended claims the invention may be practiced other wise than as specifically described.

What is claimed is:

1. A battery comprising a cathode, an anode, and an electrolyte,
wherein capacity of the anode is expressed by the sum of a capacity component determined by insertion and extraction of a light metal and a capacity component determined by deposition and dissolution of a light metal, and
the electrolyte contains at least one of carboxylate ester and carboxylate ions.

2. A battery according to claim 1, wherein the electrolyte contains at least one of carboxylate ester expressed by Chemical Formula 3 and carboxylate ions dissociated from the carboxylate ester expressed by Chemical Formula 3.
CₘHₓF₂ₘ₊₁₋ₓ—COO—CₙH_{y}F_{2n+1-y} [Chemical Formula 3]
(wherein each of m and n denotes an integer from 1 to 3 and each of x and y denotes an integer from 0 to 7).

3. A battery according to claim 2, wherein the electrolyte contains at least one of methyl propionate, methyl butyrate, and carboxylate ions dissociated from methyl propionate and methyl butyrate.

4. A battery according to claim 1, wherein the electrolyte further contains a solvent and an electrolyte salt, content of the carboxylate ester and the carboxylate ions is a total and lies in a range from 0.005 wt % to 30 wt % with respect to a total of the solvent and the electrolyte salt.

5. A battery according to claim 1, wherein the anode contains an anode material capable of inserting and extracting a light metal.

6. A battery according to claim 5, wherein the anode contains a carbon material.

7. A battery according to claim 6, wherein the anode contains at least one material selected from the group of graphite, graphitizing carbon, and non-graphitizable carbon.

8. A battery according to claim 7, wherein the anode contains graphite.

9. A battery according to claim 5, wherein the anode contains at least one material selected from the group of a simple substance, an alloy, and a compound of a metal element or a metalloid which can form an alloy in cooperation with the light metal.

10. A battery according to claim 9, wherein the anode contains at least one kind selected from the group of a simple substance, an alloy, and a compound of tin (Sn), lead (Pb), aluminum (Al), indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), and hafnium (Hf).

11. A battery according to claim 1, wherein the electrolyte contains a high molecular weight compound.

12. A battery according to claim 1, wherein the electrolyte contains a mixture of a lithium salt selected from the group of LiN(CF₃SO₂)₂, LiN(C₂F₅SO₂)₂, and LiC(CF₃SO₂)₃ and one or more other lithium salts.
